(19) United States
(12) Patent Application Publication
(10) Pub. No.: US 2013/0272556 A1
(43) Pub. Date: Oct. 17, 2013

(54) HEARING INSTRUMENT AND METHOD OF OPERATING THE SAME

(71) Applicant: Volkmar Hamacher, Hannover (DE)

(72) Inventor: Volkmar Hamacher, Hannover (DE)

(73) Assignee: Advanced Bionics AG, Zug (CH)

(21) Appl. No.: 13/884,112

(22) PCT Filed: Nov. 8, 2010
(86) PCT No.: PCT/EP2010/067057

§ 371 Date: Jun. 3, 2013

(51) Int. Cl. H04R 25/00

(52) U.S. Cl. CPC H04R 25/50
USPC 381/328

(57) ABSTRACT

A hearing instrument and a method of operating a hearing instrument are provided. The hearing instrument includes an electro-acoustic or electro-mechanical output transducer. When a low battery status of the hearing instrument is detected, a low power audio signal processing mode is selected to extend a lifetime of a battery. The low power audio signal processing mode includes reducing a gain at predefined frequencies; switching off an audio signal processing function for one or more audio frequencies; switching-off parts of a digital audio processor to reduce a duty cycle; and reducing power consumption of an audio signal preamplifier, an audio signal analog-to-digital converter or an audio signal digital-to-analog converter.

### BACKGROUND OF THE INVENTION

1. Field of the Invention

The invention relates to a method of operating a hearing instrument worn at or at least partly in the ear of a user and including a digital audio signal processing unit and an electro-acoustic or electro-mechanical output transducer.

2. Description of Related Art

Examples of such type of hearing aids are active middle ear implants and conventional electro-acoustic hearing aids.

Running out of battery power is a permanent issue in particular for users of partially implantable hearing aids, wherein the power required by the implanted part of the hearing aid is supplied by a battery of the external part. While the battery of the external part of the hearing aid in principle can be replaced quite easily, a spare battery needs to be available and, depending on the situation, the user of the hearing aid may not want to a attract attention when fiddling around with the battery. In addition, during replacement of the battery the hearing aid does not work, so that the user, depending on the degree of his hearing loss, may be more or less deaf. In particular such temporary deafness will be very disturbing in daily life, especially for active people. Battery life time in partially implantable hearing aids typically is on the order of one day.

In principle, users of conventional electro-acoustic hearing aids encounter similar problems, but to a less prominent extent, since ear battery runtimes typically are more than one week and, except for profound losses, the users of electro-acoustic hearing aids typically have a certain level of residual hearing and speech understanding without electronic amplification.

U.S. Pat. No. 7,120,500 B1 relates to a Cochlear implant, wherein, if the battery voltage falls below a first threshold, power consumption is reduced by reducing the stimulation rate applied by the implant as a function of the battery voltage; if the battery voltage falls below a second threshold, the speech processor is shut down and a low voltage alarm is triggered. When the battery voltage raises again above the first threshold value, the stimulation rate returns to the normal programmed rate. If the stimulation rate falls below a minimum rate, a warning beep is issued to indicate to the user that the processor may be shut down shortly. Alternatively, the number of channels processed by the filter and/or the number of channels selected for stimulation may be reduced. At low battery voltage another processing strategy may be selected which copes better with progressive stimulation rate reduction than the normal strategy.

European Patent Application Publication No. 1 727 394 B1 relates to an electro-acoustic hearing aid, in which the hearing aid speaker is temporarily switched on and off in order to prevent the battery voltage to fall below a certain limit at which the digital control circuit of the hearing aid would reset. If the on/off switching of the speaker occurs too frequently, the gain is progressively reduced until the battery voltage is again above the threshold value. Thus, negative effects of battery voltage drops due to too high currents, as induced by high input/output levels, are to be avoided.

U.S. Patent Application Publication No. 2009/0074203 A1 relates to an electro acoustic hearing aid which is connected via an ultra wide band (UWB) link to a belt-worn external processing device and to another hearing aid worn at the other ear. The wireless transceiver of the hearing aid may be shut off when it is detected that the power of the hearing aid is low. In addition, the hearing aid is switched to a conventional analog amplifier mode when the hearing aid power is critically low.

U.S. Pat. No. 6,904,156 B1 relates to an electro acoustic hearing aid, wherein the hearing aid audio amplifier is disabled when low battery voltage is sensed. U.S. Pat. No. 6,704,424 B2 relates to an electro acoustic hearing aid comprising an alarm system providing for an output signal whose amplitude and frequency increases as battery voltage decreases below a predetermined level. Also U.S. Pat. No. 6,310,556 B1 relates to a hearing aid having an alarm system for detecting low battery power condition, wherein in audible warning is generated when the battery output voltage drops below a first threshold voltage. When the battery output voltage drops below a second threshold voltage, the output stage of the hearing aid is shut down. International Patent Application Publication No. WO 97/01314 A1 relates to a hearing aid comprising a battery monitoring function, wherein an alarm signal is generated when low battery power condition is detected.

### SUMMARY OF THE INVENTION

It is an object of the invention to provide for a hearing instrument worn at or at least partly in the ear of a user and including a digital audio signal processing unit and an electro-acoustic or electro-mechanical output transducer, wherein the time span during which the hearing instrument is able to provide hearing assistance to the user once the battery has entered a stage of low residual battery power is extended. It is a further object to provide for a method of operating such hearing instrument.

According to the invention, these objects are achieved by a method of operating hearing instrument as set forth herein.

The invention is beneficial in that, by selecting a low power audio signal processing mode having reduced power consumption compared to the standard audio signal processing mode when low battery status has been detected. In addition to providing for an alarm signal to a user, battery life time can be extended while still providing for hearing assistance to the user—although at potentially reduced audio quality—so that the user has more time to replace the battery until the hearing instrument ceases to provide for hearing assistance. Preferably, a warning signal is provided to the user once a low battery status has been detected.

Further preferred embodiments of the invention are disclosed herein.

These and further objects, features and advantages of the present invention will become apparent from the following description when taken in connection with the accompanying drawings which, for purposes of illustration only, show several embodiments in accordance with the present invention.

### BRIEF DESCRIPTION OF THE DRAWINGS

FIG. 1 is a schematic functional block diagram of an example of a hearing instrument according to the invention;

FIG. 2 is schematic block diagram of the hearing instrument of FIG. 1 wherein some details regarding the electronic components are shown; and

FIG. 3 is schematic diagram showing an example of how the battery voltage decreases as a function of time in a hearing instrument according to the invention.

### DETAILED DESCRIPTION OF THE INVENTION

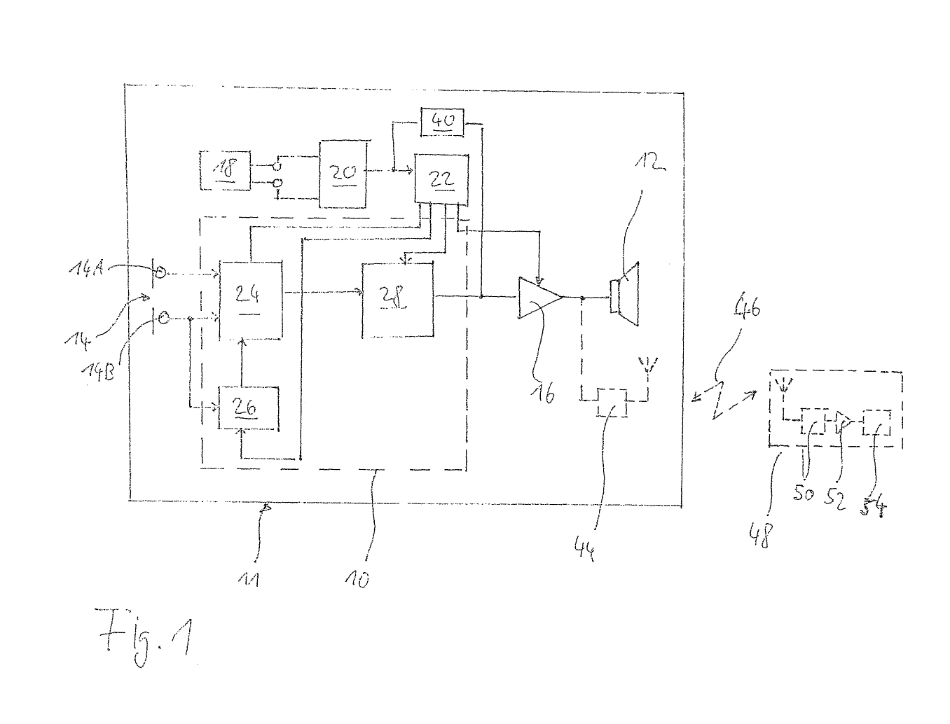

FIG. 1 relates to an example of a hearing instrument 11 to be worn at least partly in the ear of a user comprising a digital audio signal processing unit 10 and an electro-acoustic output transducer (speaker/receiver) 12, a microphone arrangement 14 for capturing audio signals from ambient sound, a power amplifier 16, a battery 18, a battery monitoring unit 20 and an audio signal processing mode selection unit 22. The audio signals captured by the microphone arrangement 14 are processed in the audio signal processing unit 10, the processed audio signals are amplified in the power amplifier 16, and the amplified processed audio signals are converted into sound by the electro-acoustic output transducer 12.

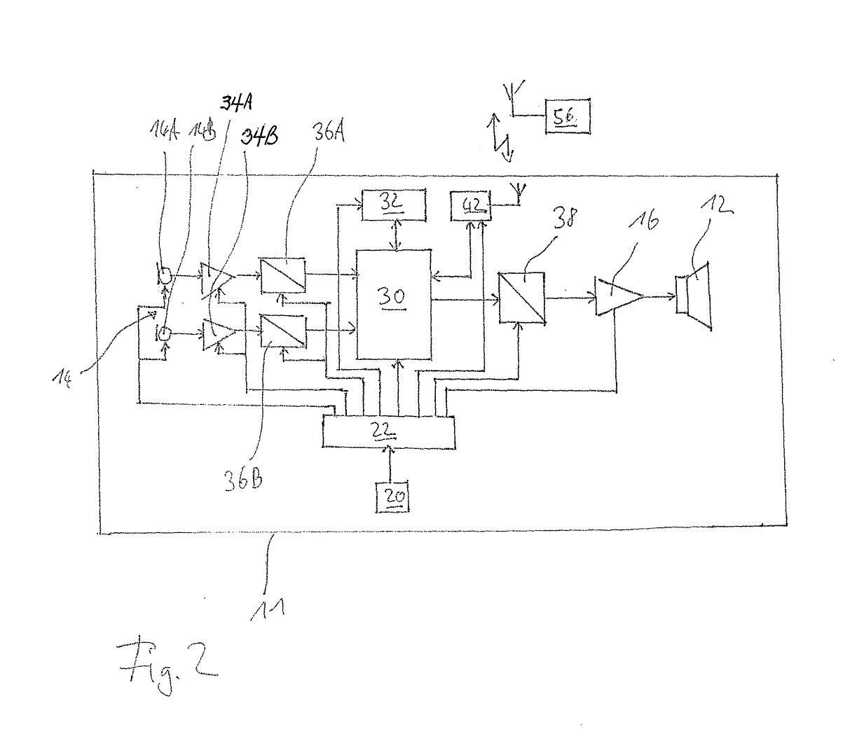

Typically, the audio signal processing unit 10 comprises an acoustic beamformer unit 24, an auditory scene classifier unit 26 and a unit 28 which processes the audio signals provided by the microphone arrangement 14 or the beamformer 24 by applying a frequency and level dependent gain to the audio signals (which are divided, to this end, into a plurality of frequency bands) in order to supply processed audio signals to the power amplifier 16. In order to supply the beam former 24 with the necessary input signals, the microphone arrangement 14 comprises at least two spaced part microphones 14A and 14B. The unit 28 may include processing schemes like feedback canceling, frequency compression, noise reduction and pinna simulation. The specific audio signal processing scheme applied in the beamformer and the unit 28 is selected according to the presently prevailing auditory scene, as detected by the classification unit 26. In practice, the units 24, 26 and 28 are functionally realized by a digital signal processor (DSP) 30 and a memory 32, as shown in FIG. 2.

Referring to FIG. 2, the hearing instrument 11 also comprises a pre-amplifier 34A for amplifying the audio signals captured by a microphone 14A and a pre-amplifier 34B for pre-amplifying the audio signals captured by the microphone 14B. The pre-amplified audio signals are supplied to a digital-to-analog converter (DAC) 36A and 36B, respectively, with the corresponding digital signals being supplied is input to the DSP 30. The digital audio output signals of the DSP 30 are supplied to an analog-to-digital converter (ADC) 38 prior being supplied as corresponding analog signals to the amplifier 16.

Referring to FIG. 1, the hearing instrument 11 also comprises an alarm unit 40 for generating an alarm/warning signal when a low battery status has been detected by the battery monitoring unit 20, which alarm signal is mixed with the audio output signals of the unit 28 in order to indicate to the user that the battery 18 needs to be replaced (typically the alarm signal is supplied only for a certain time period after detection of the low battery status).

Once the battery monitoring unit 20 has detected a low battery status, namely that the residual energy of the battery is low a pre-defined energy threshold, not only the alarm signal of the alarm unit 40 triggered but also the hearing instrument 11 is made to enter a low power audio signal processing mode having reduced power consumption compared to the standard audio signal processing mode (the hearing instrument 11 is operated the standard audio signal processing mode as long as the battery monitoring unit 20 detects a high battery status in which the residual energy of the battery 18 is above the pre-defined energy threshold).

Such change into a low power audio signal processing mode is achieved by action of the audio signal processing mode selection unit 22, which may act on the following system components: the DSP 30, the memory 32, the microphones 14A, 14B, the microphone pre-amplifiers 34A and 34B, the DACs 36A, 36B, the ADC 38 and the power amplifier 16. For example, the audio signal processing mode selection unit 22 may serve to reduce power consumption of the audio signal pre-amplifiers 34A, 34B, the DACs 36A, 36B and/or the ADC 38 by reducing the dynamic range thereof.

In addition, the audio signal processing mode selection unit 22 may serve to switch off, at least on a regular temporary base for at least reducing the duty cycle thereof, parts of the DSP 30 and/or the memory 32. When reducing the power consumption of the DSP 30, entire processing cores (if there is a multi-core architecture) or parts thereof may be switched off. The audio signal processing mode selection unit 22 also may act on at least one of the microphones 14A, 14B to switch off the respective microphone.

Referring to FIG. 2, the hearing instrument 11 may comprise a receiver/transceiver unit 42 for reception and/or detection of incoming wireless audio signals or control data via a wireless link from an external device 56, such a wireless remote microphone or another hearing instrument 11. The receiver/transceiver unit 42 comprises a transceiver (in case of a bidirectional—usually digital—link) or a receiver (in case of an unidirectional—usually analog—link). Incoming signals detected by the receiver/transceiver unit 42 may include baseband or RF (radio frequency) signals including audio data and/or control data. The receiver/transceiver unit 42 may be formed by a T-coil unit or an FM (frequency modulation) receiver. The data may be received via a standard data network, such as a Bluetooth or Zigbee network.

The audio signal processing mode selection unit 22 may act to completely switch off such transceiver/receiver unit 42 or to make it reduce the data exchange rate via the wireless link. In any case, the receiver/transceiver unit 42 may be switched off by the audio signal processing mode selection unit 22 at least on a regular temporary base for at least reducing the duty cycle thereof.

Preferably, when in the low power audio signal processing mode a certain circuitry is switched off by the audio signal processing mode selection unit 22, the clock input of said circuitry and/or the supply voltage to said circuitry may be switched off.

More on a functional basis, the audio signal processing mode selection unit 22 may change the audio signal processing in the unit 28 in a manner that the gain at pre-defined frequencies compared to the gain at other frequencies less relevant for speech intelligibility may be selectively reduced. In particular, the gain at frequencies below 0.5 kHz and/or above 4 kHz may be reduced relative to the gain at frequencies between 0.5 and 4 kHz. In particular, the frequencies at which the gain is reduced in the low power audio signal processing mode and/or the extent to which the gain is reduced at said frequencies in the low power audio signal processing mode may be selected based on a spectral power consumption profile and the articulation index.

Also, the following audio signal processing functions of the audio signal processing unit 10 may be switched off for at least part of the audio frequencies: feedback canceling, auditory scene classification, frequency compression, noise reduction, pinna simulation and acoustic beamforming. For example, when switching off the acoustic beamforming function, the beam former unit 24 and one of the two audio signal input channels including the respective microphone 14A, 14B, the pre-amplifier 34A, 34B and the ADC 36A, 36B may be switched off. Alternatively, the acoustic beam forming function may switched off only partially by reducing the number of frequency bands.

In the low power audio signal processing mode also the maximum loudness the hearing instrument 11 may achieve may be reduced.

At least part of the power consumption savings achieved by switching off feedback canceling, auditory scene classification, frequency compression, noise reduction, pinna simulation and acoustic beamforming is achieved by the correspondingly reduced data processing requirements, whereby power consumption of the DSP 30 is reduced.

In addition to the above described low power audio signal processing mode a very low power mode could be implemented, wherein, when the battery monitoring unit 20 determines that the residual battery energy is below a second threshold value lower than the energy threshold value of the low battery status (such battery condition corresponds to a very low battery status of the hearing instrument 11), a speech monitoring function is activated by the audio signal processing mode selection unit 22 for determining from the audio signals captured by the arrangement of microphones 14A, 14B whether speech signals are present at the arrangement of microphones 14A, 14B, and wherein all functions of the hearing instrument 11 except for a speech monitoring function are disabled as long as no speech signals are detected (for the speech monitoring function it is sufficient that only one of the microphones 14A, 14B is active). Thereby, the hearing instrument 11 enters a kind of the power saving “sleep mode” as long as no speech is detected. When the battery has such very low battery status, part of the hearing instrument 11 functions are reactivated as long as speech signals are detected; in particular, the DSP 30, especially its output stage, may be reactivated.

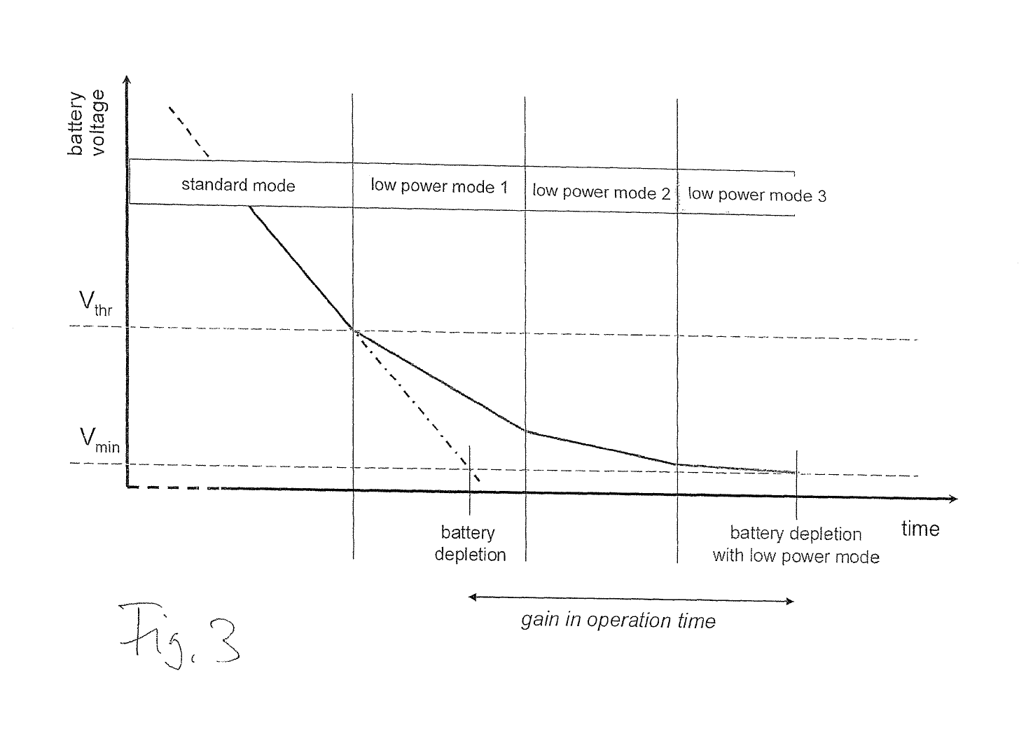

A plurality of different low power audio signal processing modes may be implemented which are selected subsequently by the audio signal processing mode selection unit 22 as a function of the residual energy level (voltage) of the battery 18 as detected by the battery monitoring unit 20. In particular, the lower the detected residual energy of the battery 18 is, the more pronounced the reduction in power consumption (and the corresponding reduction of audio performance) has to be. In FIG. 3 an example is shown of how the battery voltage decreases with time when three different low power audio signal processing modes 1 to 3 are employed subsequently, wherein the power consumption—and the residual functionality—of the hearing instrument is subsequently reduced when advancing from the standard mode (which is left when the battery voltage reaches a threshold Vₜₕᵣ) to the low power modes 1 to 3 (which are triggered by respective threshold voltages). Thus, the minimum operating voltage Vₘᵢₙ of the battery 18 is reached later compared to the case without low power modes (dashed line in FIG. 3).

The respective measures taken in the respective low power audio signal processing mode may be defined individually in order to provide the optimal trade-off between acceptable sound quality degradations and the achievable operation time extension for the individual user.

The present invention not only may be applied to hearing instruments having an electro-acoustic output transducer, but rather also may be applied to hearing instruments comprising an active middle ear implant. Such a hearing instrument is schematically indicated in FIG. 1 in dashed lines, wherein the processed audio signals are supplied to a transmission unit 44 for transmitting the audio signals via a transcutaneous wireless link 46 to an implanted arrangement 48 comprising a receiver 50, and amplifier 52 and an electro mechanical output transducer 54 which may be mechanically coupled to the ear drum, the ossicular chain or the cochlea.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

What is claimed is:

1-14. (canceled)

15. A method of operating a hearing instrument worn at or at least partly in the ear of a user and including a digital audio signal processing unit and an electro-acoustic or an electro-mechanical output transducer for stimulating hearing of the user using audio signals processed by the digital audio signal processing unit, the method comprising:
monitoring a residual energy of a battery of the hearing instrument;
detecting a low battery status of the hearing instrument when the residual energy of the battery is below a predefined energy threshold and a high battery status of the hearing instrument when the residual energy of the battery is above said energy threshold;
selecting, as long as the high battery status is detected, a standard audio signal processing mode; and
selecting, once the low battery status has been detected, a low power audio signal processing mode having reduced power consumption compared to the standard audio signal processing mode to extend battery lifetime, wherein the low power audio signal processing mode includes at least one of the following changes compared to the standard audio signal processing mode:
selectively reducing a gain at one or more predefined frequencies;
switching-off at least one of the following audio signal processing functions for at least one audio frequency: feedback canceling, auditory scene classification, frequency compression, noise reduction, pinna simulation, and acoustic beamforming;
switching-off at least one of parts of the digital audio signal processing unit, including a processor and a memory, at least on a regular temporary basis to reduce a duty cycle thereof; and
reducing power consumption of at least one of an audio signal preamplifier, an audio signal analog-to-digital converter, and an audio signal digital-to-analog converter by reducing a dynamic range thereof.

16. The method of claim 15, wherein selectively reducing the gain at one or more predefined frequencies in the low power audio signal processing mode comprises reducing a gain at frequencies of at least one of a range below 0.5 kHz and a range above 4 kHz is reduced relative to a gain at frequencies between 0.5 and 4 kHz in the standard audio signal processing mode.

17. The method of claim 15, wherein selectively reducing a gain at one or more predefined frequencies in the low power audio signal processing mode comprises selecting at least one of the frequencies at which the gain is reduced and an extent to which the gain is reduced at said frequencies based on a spectral power consumption profile and an articulation index.

18. The method of claim 15, wherein, switching-off the acoustic beamforming function comprises switching-off at least one of the audio signal channels including the respective microphone, the preamplifier and the analog-to-digital converter.

19. The method of claim 15, wherein switching-off the acoustic beamforming function comprises reducing a number of frequency bands.

20. The method of claim 15, wherein selecting the low power audio signal processing mode comprises reducing a maximum loudness of an output of the hearing instrument.

21. The method of claim 15, wherein selecting the low power audio signal processing mode comprises switching-off circuitry for at least one of reception and detection of incoming wireless audio signals or control data from an external device at least on a regular temporary basis to at least reduce a duty cycle thereof.

22. The method of claim 15, wherein selecting the low power audio signal processing mode comprises:
switching-off a binaural wireless data link to another hearing instrument; or
reducing the data exchange rate via the binaural wireless data link.

23. The method of claim 15, further comprising:
detecting a very low battery status of the hearing instrument when the residual energy is below a second threshold lower than the energy threshold;
activating, once the very low battery status of the hearing instrument is detected, a speech monitoring function that determines from audio signals captured by a microphone of the hearing instrument whether speech signals are present at the microphone;
disabling all functions of the hearing instrument except for speech monitoring function as long as no speech signals are detected; and
reactivating part of the disabled hearing instrument functions as long as speech signals are detected.

24. The method of claim 15, wherein selecting the low power audio signal processing mode comprises switching-off parts of the hearing instrument, wherein the switching-off the parts includes switching-off at least one of a clock input of the parts of the hearing instrument and a supply voltage to the parts of the hearing instrument.

25. The method of claim 15 further comprising, upon detecting the low battery status, providing a warning signal to the user.

26. The method of claim 15, wherein the hearing instrument comprises an electro-acoustic transducer for vibrating an eardrum of the user.

27. The method of claim 15, wherein the hearing instrument comprises an active middle ear implant.

28. A hearing instrument to be worn at or at least partly in the ear of a user and including a digital audio signal processing unit and an electro-acoustic or an electro-mechanical output transducer for stimulating hearing of the user using audio signals processed by the digital audio signal processing unit, the hearing instrument comprising:
means for monitoring a residual energy of a battery of the hearing instrument and for detecting a low battery status of the hearing instrument if the residual energy of the battery is below a predefined energy threshold and a high battery status of the hearing instrument if the residual energy of the battery is above said energy threshold;
means for selecting, as long as the high battery status is detected, a standard audio signal processing mode of the audio signal processing unit and for selecting, once the low battery status has been detected, a low power audio signal processing mode of the audio signal processing unit having reduced power consumption compared to the standard audio signal processing mode to extend battery lifetime; and
means for providing, once the low battery status has been detected, a warning signal to the user,
wherein the low power audio signal processing mode includes means for changing at least one of the following compared to the standard audio signal processing mode:
selectively reducing a gain at one or more predefined frequencies;
switching-off at least one of the following audio signal processing functions for at least one audio frequency: feedback canceling, auditory scene classification, frequency compression, noise reduction, pinna simulation, and acoustic beamforming;
switching-off at least one of parts of the digital audio signal processing unit, including a processor and a memory, at least on a regular temporary basis to reduce a duty cycle thereof; and
reducing power consumption of at least one of an audio signal preamplifier, an audio signal analog-to-digital converter and an audio signal digital-to-analog converter by reducing a dynamic range thereof.
